(19) United States
(12) Patent Application Publication
(10) Pub. No.: US 2026/0332713 A1
(43) Pub. Date: Oct. 22, 2026

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: YUICHIRO SATO, Kanagawa (JP)

(21) Appl. No.: 19/640,520

(22) Filed: Apr. 7, 2026

(30) Foreign Application Priority Data
Apr. 17, 2025 (JP) 2025-068351

(51) Int. Cl. H04N 1/00; H04L 9/40

(52) U.S. Cl. CPC H04N 1/00859; H04L 63/04; H04N 1/00209; H04N 1/00824

(57) ABSTRACT

The present disclosure is directed to an information processing apparatus acquires image data read from an original by a reading unit; inspects whether or not predetermined information is included in the image data; and according to an inspection result that the predetermined information is included in the image data, in a case where a pre-registered notification destination to which a warning is to be notified and a transmission destination of the image data are different, notifies the pre-registered notification destination of a warning indicating that the image data including the predetermined information is to be transmitted.

### BACKGROUND

### Field of the Technology

The present disclosure relates to an information processing apparatus having an alert notification function, a control method therefor, and a storage medium.

### Description of the Related Art

In image forming apparatuses, for example, alert functions that notify a user via e-mail or the like that an event has occurred, such as running out of paper, an error, or the lifespan of a consumable or a part, and functions (image transmission functions) that transmit a scanned image as an email with an attachment are known. Also, in an alert function, a function is known that detects that a confidential document containing confidential information such as trade secrets has been scanned and notifies an administrator of the organization that there is a risk of confidential information leakage. Japanese Patent Application Laid-Open No. 2024-13374 proposes a technology in which, when an incident occurs in an information processing apparatus, a software component that caused the incident is identified, and if the estimation confidence thereof is equal to or greater than a predetermined threshold, an alert is notified to an organization capable of handling the incident.

However, the above-mentioned conventional technology has the following issues. For example, in a case where email transmission of a scanned image of a confidential document is carried out with the intention of taking away confidential information, there is a case where an image transmission destination email address and an alert notification destination email address are the same. When the administrator himself, who is the alert notification destination, has taken away the confidential information, even if alert notification is performed, the person himself who performed the confidential information leakage operation receives the alert notification, so the mail is ignored and the occurrence of the alert cannot be detected. Also, even when a plurality of alert notification destinations are set, there is a risk that evidence of the confidential information leakage may be hidden in advance due to the person who performed the confidential information leakage operation receiving the alert notification mail.

### SUMMARY

The present disclosure enables realization of, for example, a new mechanism for suitably notifying an alert.

One aspect of the present disclosure provides an information processing apparatus comprising: one or more memory devices that store a set of instructions; and one or more processors that execute the set of instructions to: acquire image data read from an original by a reading unit; inspect whether or not predetermined information is included in the image data; and according to an inspection result that the predetermined information is included in the image data, in a case where a pre-registered notification destination to which a warning is to be notified and a transmission destination of the image data are different, notify the pre-registered notification destination of a warning indicating that the image data including the predetermined information is to be transmitted.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing a system configuration of an image forming apparatus according to one embodiment.

FIG. 2 is a diagram showing a software configuration of an image forming apparatus according to one embodiment.

FIG. 3 is a diagram showing a configuration of a transmission job according to one embodiment.

FIG. 4 is a flowchart for explaining alert notification processing of an image forming apparatus according to one embodiment.

FIG. 5A and FIG. 5B are diagrams showing an example of a destination editing confirmation screen and a destination confirmation screen of an image forming apparatus according to one embodiment.

FIG. 6 is a flowchart for explaining alert notification processing of an image forming apparatus according to one embodiment.

FIG. 7 is a flowchart for explaining alert notification processing of an image forming apparatus according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <System Configuration>

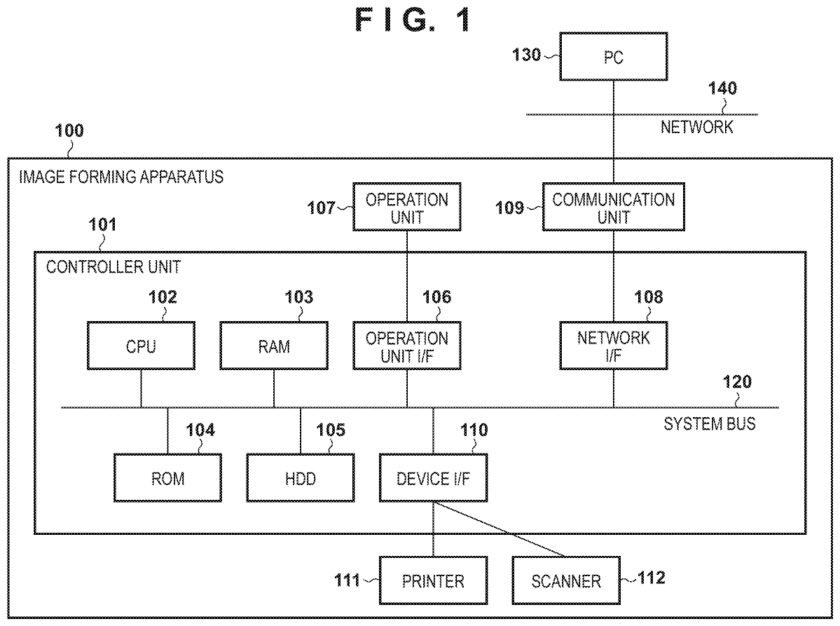

Below, a first embodiment of the present disclosure will be described. With reference to FIG. 1, a system configuration of an image forming apparatus 100 according to the present embodiment will be described. In the present embodiment, the image forming apparatus 100 will be described as an example of an information processing apparatus, but an apparatus to which the present embodiment is applicable is not limited thereto. For example, an apparatus having a transmission function for transmitting data to the outside of the apparatus, such as an image processing apparatus, an image transmission apparatus, a digital front end (DFE), or a personal computer (PC), is an information processing apparatus to which the present embodiment is applicable.

The image forming apparatus 100 includes a controller unit 101, an operation unit 107, a communication unit 109, a printer 111, and a scanner 112. Also, the controller unit 101 includes a CPU 102, a RAM 103, a ROM 104, an HDD 105, an operation unit I/F 106, a network I/F 108, and a device I/F 110. Each component is connected via a system bus 120, and can exchange data with each other. The controller unit 101 is connected to the printer 111 which is an image output device and the scanner 112 which is an image input device, and controls input/output of image information. Also, the controller unit 101 controls the operation unit 107 and the communication unit 109.

When a user uses an image transmission function, the controller unit 101 controls the scanner 112 to acquire image data. Also, the controller unit 101 is connected to a network 140, and performs transmission of a transmission job 300, which will be described later, through the communication unit 109. The transmission job 300 is a data structure for a case of transmitting by, for example, e-mail. As shown in FIG. 3, the transmission job 300 is configured to include a header part 301 in which destination information is stored, a text part 302 in which text is stored, and a data part 303 in which image data is stored.

The CPU 102 controls the entire system of the image forming apparatus 100. The RAM 103 is a system work memory for the CPU 102 to operate, and is an image memory for temporarily storing image data. Also, in the RAM 103, programs and data such as an operating system, system software, and application software are also arranged. The ROM 104 stores a boot program of the system. A hard disk drive (HDD) 105 stores an operating system, system software, application software, transmission jobs, and destination email addresses of alerts (alert notification destinations) or the like when an error or transmission of a confidential document is detected.

The operation unit I/F 106 is an interface with the operation unit 107, and outputs information to be displayed on the operation unit 107 to the operation unit 107. Also, the operation unit I/F 106 accepts information input by a user from the operation unit 107. The operation unit 107 is configured to include a touch panel type liquid crystal display unit and physical keys. The network I/F 108 is connected to the communication unit 109, performs various types of communication control with an external apparatus, and performs transmission of transmission jobs, alerts, and the like. The device I/F 110 connects the scanner 112 and the printer 111, which are image input/output devices, and the controller unit 101, and performs input/output of image data. The network I/F 108 is connected to the network 140, communicates with an external apparatus such as a PC 130 via the network, and manages input/output of various types of information. The PC 130 is a host computer (personal computer), and is connected to a network such as the network 140 via a network connection unit.

### <Software Configuration of Image Forming Apparatus>

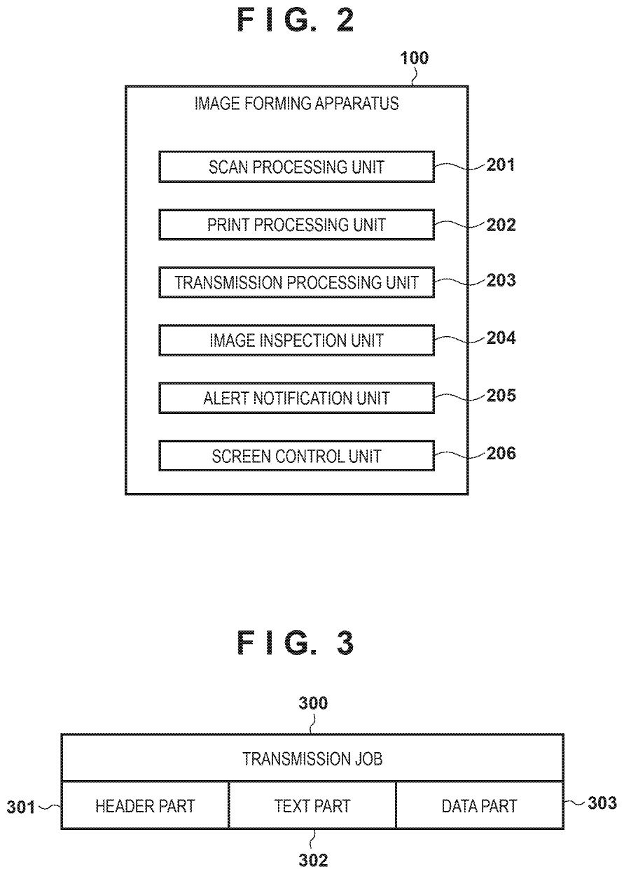

With reference to FIG. 2, a software configuration of the image forming apparatus 100 according to the present embodiment will be described. The image forming apparatus 100 includes, as a software configuration, a scan processing unit 201, a print processing unit 202, a transmission processing unit 203, an image inspection unit 204, an alert notification unit 205, and a screen control unit 206.

The scan processing unit 201 controls the scanner 112 through the device I/F 110, inputs a paper document as image data, and creates the transmission job 300. The scanner is an example of a reading unit. Note that, in the present embodiment, description is given by an example of the image forming apparatus 100 having the scanner 112, but a form using a scanner of an external apparatus may be used. The print processing unit 202 controls the printer 111 through the device I/F 110, and prints and outputs the image data onto paper. The transmission processing unit 203 controls the communication unit 109 through the network I/F 108, and transmits the transmission job 300 by e-mail. Here, although transmitting information by e-mail is described as an example, there is no limitation to an application destination disclosed in the present embodiment, and information may be transmitted in another form.

The image inspection unit 204 analyzes the image data defined in the data part 303 of the transmission job 300 by OCR or the like, and in a case where confidential information is included, transmits an alert notification mail regarding confidential document transmission through the alert notification unit 205. As an example of a document containing confidential information, there is, for example, a document containing characters such as “company secret” or “confidential”. Note that, in the present embodiment, as an example of notifying an alert, a case where confidential information is included in information to be transmitted will be described, but the scope of application of the present embodiment is not limited. In particular, it is not limited to confidential information, and it is sufficient if predetermined information is included in the information to be transmitted. Here, the predetermined information is any information set in advance (for example, it may be personal information, organizational information, or the like), and may be settable by an administrator or the like. As the settable predetermined information, for example, even if it is not confidential information, it may be content that is not permitted to be transmitted to the outside. Also, as the confidential information and the predetermined information, not only character strings but also an image can be included. Note that, in the image processing apparatus according to the present embodiment, since information leakage due to an operation by an administrator is restricted, it is desirable to provide some kind of restriction regarding authority to set the predetermined information. For example, unless approval of another administrator or the like is obtained, the content of the predetermined information may be made unchangeable. Alternatively, a person different from the administrator may have authority to change the content of the predetermined information.

The alert notification unit 205 manages a type of an event to be notified as an alert as an alert type, and determines an alert notification destination according to the alert type. Also, the alert notification unit 205 notifies an alert to the alert notification destination at a time of occurrence of an event in which alert notification should be performed, such as when confidential document transmission is detected. Table 1 shows an example of alert types managed by the alert notification unit 205.

TABLE 1

CONFIDENTIAL DOCUMENT TRANSMISSION
TONER LOW

Examples of alert types include “confidential document transmission” corresponding to external transmission of image data containing confidential information, which is a confidential information leakage operation, “toner low” for a case where a remaining toner amount becomes equal to or less than a certain threshold, and “jam” for a case where a paper jam occurs. For example, if the alert notification unit 205 manages alert types as shown in Table 1 above, an alert notification mail is transmitted in a case where transmission of a confidential document is performed and in a case where the remaining toner amount becomes equal to or less than the certain threshold. A transmission destination is set by an email address described in alert notification destinations, which will be described later. The alert notification unit 205 further manages alert notification destinations. Table 2 shows an example of alert notification destinations managed by the alert notification unit 205.

TABLE 2

adminA@example.com
adminB@example.com
adminC@example.com

According to Table 2, email addresses are set as the alert notification destinations. Specifically, settings are made to transmit the alert notification mail to “adminA@example.com”, “adminB@example.com”, and “adminC@example.com”.

The screen control unit 206 controls the operation unit 107 through the operation unit I/F 106, and accepts information input by the user via the operation unit 107. Also, the screen control unit 206 generates a screen to be displayed on the operation unit 107. Each block shown in FIG. 2 indicates software (a program) stored in the ROM 104 or the HDD 105, and the CPU 102 implements processing of flowcharts described later by reading it into the RAM 103 and executing it. The alert type and the alert notification destination can be added or changed by a setting screen displayed on the operation unit 107 via the screen control unit 206, or by an alert notification setting screen (not shown) displayed on the PC 130 via the screen control unit 206 and the communication unit 109.

### <Alert Notification Processing>

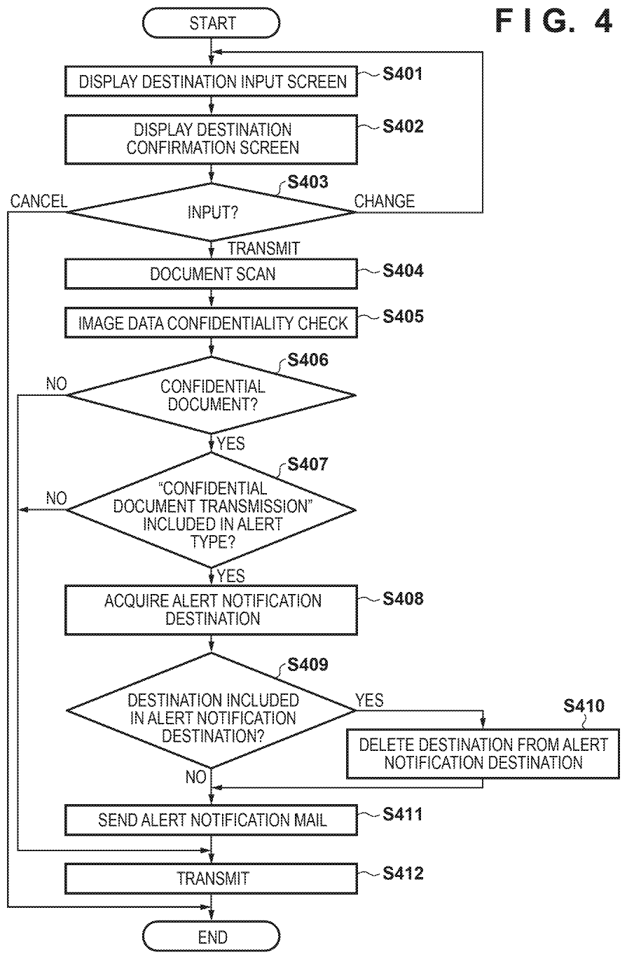

With reference to FIG. 4, a processing procedure of alert notification processing in the image transmission function executed by the image forming apparatus 100 according to the present embodiment will be described. Processing described below is realized by, for example, the CPU 102 of the image forming apparatus 100 reading a program for realizing each software module stored in the ROM 104 or the HDD 105 into the RAM 103 and executing it. Processing of this flowchart is started by the screen control unit 206 detecting that the user instructed calling of the image transmission function on a menu screen (not shown) displayed on the operation unit 107.

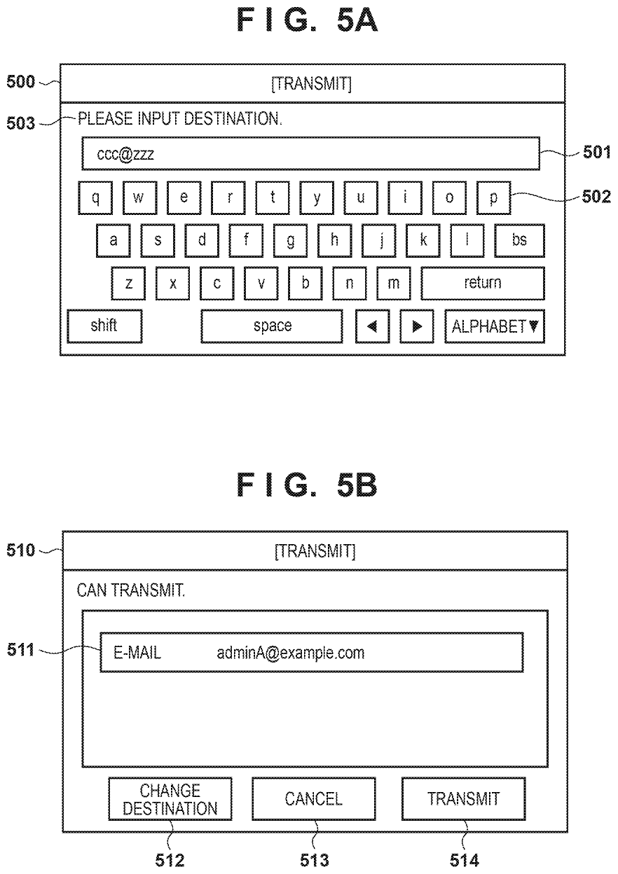

In step S401, the transmission processing unit 203 causes the operation unit 107 to display a destination input screen 500 via the screen control unit 206. On the destination input screen 500 shown in FIG. 5, a message 503 “Please input a destination.” for prompting content of an operation on this screen by the user is displayed. In an input field 501, content input by a keyboard 502 is displayed. By operating each key of the keyboard 502 displayed on the screen, it is possible to input a destination which is an email address of a transmission destination of a document.

When destination input is completed via the destination input screen 500, in step S402, the transmission processing unit 203 displays a destination confirmation screen 510 via the screen control unit 206. On the destination confirmation screen 510 shown in FIG. 5, the set destination is displayed in a destination 511. When an operation of a change button 512 is accepted, the transmission processing unit 203 displays the destination input screen 500 and accepts a change of the destination. When an operation of a cancel button 513 is accepted, the processing is ended. Also, when an operation of a transmit button 514 is accepted, transmission processing is executed.

In step S403, the transmission processing unit 203 accepts and determines an operation input by the user on the destination confirmation screen. For example, when the change button 512 is operated by the user, the processing is returned to step S401, and when the cancel button 513 is operated, the processing of this flowchart is ended. Also, when the transmit button 514 is operated, the transmission processing unit 203 saves the destination in the RAM 103 and proceeds to step S404.

In step S404, the transmission processing unit 203 operates the scanner 112 via the scan processing unit 201 to read a document, generates image data, and proceeds to step S405. In step S405, the image inspection unit 204 checks whether confidential information (predetermined information) is included in the image data generated by the scan processing unit 201. The check processing may be any method as long as presence or absence of confidential information can be determined, such as whether confidential information is included in text by extracting text by OCR, or determination by a feature amount of image data or image search.

In step S406, in a case where it is determined that confidential information is included in the image data according to an inspection result of step S405, the transmission processing unit 203 determines to transmit an alert notification mail and proceeds to step S407. On the other hand, in a case where it is determined that confidential information is not included in the image data, the transmission processing unit 203 determines that a confidential information leakage operation is not performed, and proceeds to step S412 without performing alert notification.

In step S407, the alert notification unit 205 acquires the alert type from the HDD 105 into the RAM 103. In a case where “confidential document transmission” is included in the alert type, the process proceeds to step S408, and in a case where it is not included, the process proceeds to step S412. In step S408, the alert notification unit 205 reads the alert notification destination from the HDD 105 into the RAM 103, and the process proceeds to step S409. In step S409, the alert notification unit 205 confirms whether or not an email address of the destination is included in the alert notification destination. For example, in a case where the alert notification destination is Table 2 and the destination is “adminA@example.com”, it is determined that an email address of the destination is included in the alert notification destination, and the process proceeds to step S410. On the other hand, in a case where an email address of the destination is not included in the alert notification destination, the process proceeds to step S411.

In step S410, the alert notification unit 205 deletes the email address of the destination from the alert notification destination, and the process proceeds to step S411. For example, in the case where the alert notification destination is Table 2, if the destination of the transmission is “adminA@example.com”, “adminB@example.com” and “adminC@example.com” are selected as the alert notification destination.

In step S411, the alert notification unit 205 transmits a confidential document transmission alert mail, which indicates that confidential document transmission has been performed, to the set alert notification destination, and the process proceeds to step S412. In step S412, the transmission processing unit 203 transmits the image data to the destination as the transmission job 300, and ends the processing of this flowchart.

As described above, the information processing apparatus according to the present embodiment acquires image data read from an original by a reading unit, and inspects whether or not predetermined information is included in the image data. According to an inspection result that the predetermined information is included in the image data, in a case where a pre-registered notification destination to which a warning is to be notified and a transmission destination of the image data are different, this information processing apparatus notifies the pre-registered notification destination of a warning indicating that image data including the predetermined information is to be transmitted. Also, this information processing apparatus transmits the image data to the transmission destination. In this way, according to the present embodiment, by not performing alert notification to a person himself/herself regarding a confidential information leakage operation performed by the administrator himself/herself who is an alert notification destination, only other administrators can appropriately receive the alert notification.

Note that, in the present embodiment, control has been described in which the image data is transmitted to the destination in step S412 even in the case where a confidential document is detected in step S406. However, in a case where a confidential document is detected, the image data does not have to be transmitted. Also, in step S410, control may be performed such that transmission of the image data is not performed in a case where the alert notification destination becomes empty due to deletion of the alert notification destination and alert notification cannot be performed.

### Second Embodiment

A second embodiment will be described below. In the first embodiment described above, when an event included in the alert type occurred, an alert mail was transmitted to the same alert notification destination regardless of the event. If the transmission destination of a confidential document and the alert notification destination email address match, no one can detect a confidential information leakage operation performed by the administrator himself/herself who is the confidential document transmission alert notification destination. In the present embodiment, in a case of a configuration in which a different alert notification destination can be separately designated for each alert type, an embodiment will be described in which a confidential information leakage operation performed by the administrator himself/herself who is the confidential document transmission alert notification destination is notified to an alert notification destination of another alert type. Here, description will be given centering on differences from the first embodiment described above.

The alert notification unit 205 manages an alert type and an alert notification destination, which is an email address of a destination, in association with each other. Table 3 shows an example of alert notification destinations managed by the alert notification unit 205. The table shown in Table 3 is an example of a table that defines a type for which a warning is to be given and a notification destination to notify of a corresponding warning for a respective type in association with each other.

TABLE 3

| | NOTIFICATION DESTINATION |
|---|---|
| ALERT TYPE | EMAIL ADDRESS |
| CONFIDENTIAL DOCUMENT | adminA@example.com |
| TRANSMISSION | |
| TONER LOW | adminB@example.com |
| JAM | adminC@example.com |

In the alert notification destination, an alert type indicating an event serving as a trigger for performing alert notification and an email address serving as a transmission destination of the alert notification are defined in association with each other. As examples of the alert type, “confidential document transmission” which is external transmission of image data containing confidential information, “toner low” in which a remaining toner amount has become equal to or less than a certain threshold, and “jam” in which a paper jam has occurred are included. The “toner low” alert is a case where toner, which is a consumable used for an image forming service, has become equal to or less than a certain threshold, and is a warning regarding a remaining amount of a consumable. As the warning regarding the remaining amount of a consumable, it may be another consumable such as, for example, paper. The “jam” alert is a warning regarding a malfunction of a provided service. Warnings regarding malfunctions are not limited to jams, and any malfunction can be registered. Also, it may be a warning regarding a license such as a speed license. In this way, any other type may be included as the alert type.

According to the example of Table 3, when transmission of a confidential document is performed, a confidential document transmission notification mail is transmitted to “adminA@example.com”. Also, when the remaining toner amount becomes equal to or less than the certain threshold, a toner low notification mail is transmitted to “adminB@example.com”. Also, when a paper jam occurs, a jam occurrence notification mail is transmitted to “adminC@example.com”.

### <Alert Notification Processing>

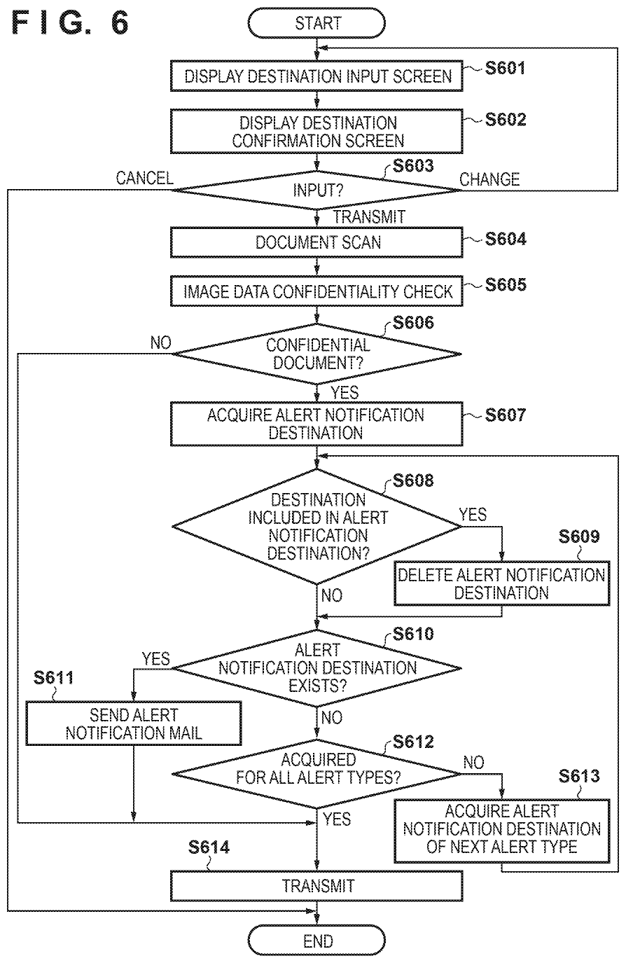

With reference to FIG. 6, a processing procedure of alert notification processing in the image transmission function executed by the image forming apparatus 100 according to the present embodiment will be described. Processing described below is realized by, for example, the CPU 102 of the image forming apparatus 100 reading a program for realizing each software module stored in the ROM 104 or the HDD 105 into the RAM 103 and executing it. Processing of this flowchart is started by the screen control unit 206 detecting that the user instructed calling of the image transmission function on a menu screen (not shown) displayed on the operation unit 107. Note that description of processing similar to the flowchart of FIG. 4 will be omitted. That is, step S601 to step S606, step S609, step S611, and step S614 are similar to the processing of step S401 to step S406, step S410, step S411, and step S412, and thus description thereof will be omitted.

In step S607, the alert notification unit 205 acquires an alert notification destination whose alert type is “confidential document transmission” from the HDD 105 into the RAM 103, and proceeds to step S608. For example, in a case where alert notification destinations are defined as in Table 3, the notification destination email address of the alert notification destination corresponding to the alert type “confidential document transmission” is “adminA@example.com”.

In step S608, the alert notification unit 205 confirms whether or not the email address of the transmission destination to which the confidential document is to be transmitted is included in the notification destination email address of the alert notification destination acquired in step S607 above. For example, in a case where Table 3 is the alert notification destination of the alert type “confidential document transmission” acquired in step S607 and the transmission destination of the confidential document is “adminA@example.com”, it is determined that the same email address is included, and the process proceeds to step S609. In step S609, the alert notification unit 205 deletes the corresponding email address and proceeds to step S610. On the other hand, in a case where the same email address is not included in the alert notification destination, the process proceeds to step S610.

In step S610, the alert notification unit 205 confirms whether or not there is an alert notification destination. For example, in a case where all alert notification destinations are deleted in step S609 and there is not even one (none exists) alert notification destination email address, the process proceeds to step S612. In a case where there is (one exists) an alert notification destination, the process proceeds to step S611.

In step S612, the alert notification unit 205 confirms whether or not alert notification destinations for all alert types “confidential document transmission”, “toner low”, and “jam” have been acquired. Here, because it was determined in step S610 that there is not even one alert notification destination email address, other available email addresses are confirmed. In a case where alert notification destinations of all alert types have been acquired, the process proceeds to step S614, and in a case where they have not been acquired, the process proceeds to step S613. In step S613, the alert notification unit 205 acquires an alert notification destination matching one of the alert types not yet acquired in step S607 and step S613 from the HDD 105 into the RAM 103, and proceeds to step S608. For example, if only the alert notification destination of the alert type “confidential document transmission” has been acquired in step S607, an alert notification destination of “toner low”, which is one of the next different alert types, can be acquired and used.

As described above, the information processing apparatus according to the present embodiment further includes a storage unit that stores a table that defines a type for which a warning is to be given and a notification destination to notify of a corresponding warning for a respective type in association with each other. Here, the type for which the warning is to be given includes a first type for warning that the image data including predetermined information is to be transmitted, and another type. Also, the information processing apparatus notifies a warning to a notification destination defined in association with another type in a case where a pre-registered notification destination associated with the first type and a transmission destination of image data match. In this way, according to the present embodiment, even in a case where the transmission destination of a confidential document and the alert notification destination of the event type “confidential document transmission” match, a confidential document transmission alert notification can be transmitted to an alert notification destination of another event type. Accordingly, even if it is confidential document transmission which is a confidential information leakage operation performed by the administrator himself/herself, it can be detected by alert notification.

### Third Embodiment

A third embodiment will be described below. In the first embodiment described above, at a time of confidential document transmission which is a confidential information leakage operation, in a case where an email address of an alert notification destination and an email address which is a transmission destination of a document match, control was performed to delete the email address so that alert notification is not transmitted to the email address.

At a time of alert notification destination setting by an administrator, if confidential document transmission is performed to the same destination as an email address set as an alert notification destination for operation confirmation, alert notification is not performed. There is a possibility that the administrator may mistakenly recognize that the alert notification function is not correctly set. In the present embodiment, an example will be described which is configured to perform alert notification even in a case where confidential document transmission is performed to an email address set as an alert notification destination immediately after setting the alert notification destination. Here, description will be given centering on differences from the first embodiment described above.

The alert notification unit 205 manages a type of an event to be notified as an alert as an alert type, and determines an alert notification destination according to the alert type. Since the alert type is similar to that of the first embodiment described above, description thereof will be omitted. The alert notification unit 205 manages alert notification destinations. Table 4 shows an example of alert notification destinations managed by the alert notification unit 205.

TABLE 4

| EMAIL ADDRESS | REGISTRATION DATE AND TIME |
|---|---|
| adminA@example.com | 2025-01-10T00:00:00Z |
| adminB@example.com | 2024-12-10T00:00:00Z |
| adminC@example.com | 2024-12-10T00:00:20Z |

In the present embodiment, in the alert notification destination, an email address which is a transmission destination of alert notification and a registration date and time which is a date and time when the email address of the alert notification destination was registered are defined in association with each other.

### <Alert Notification Processing>

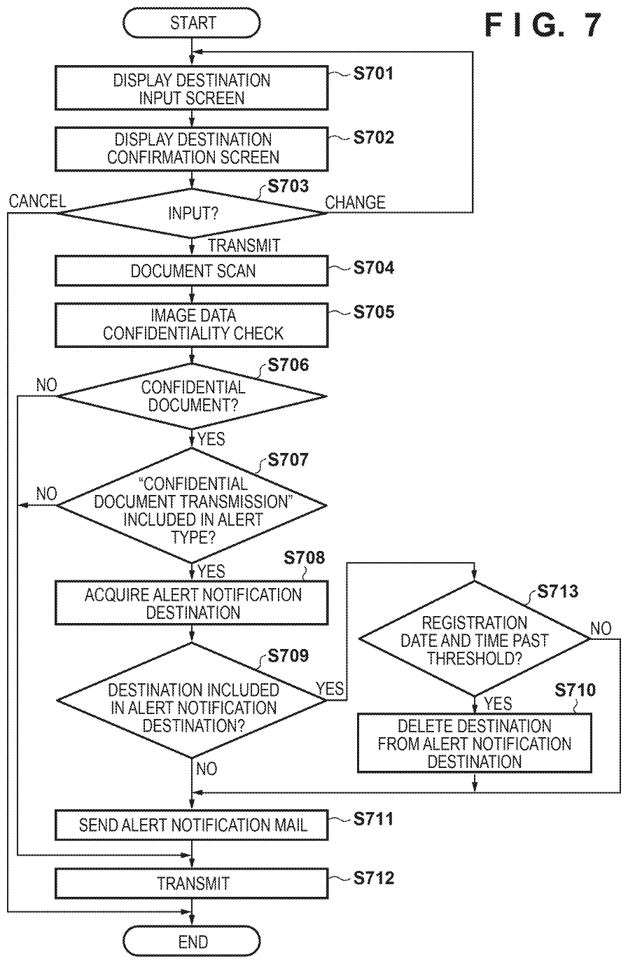

With reference to FIG. 7, a processing procedure of alert notification processing in the image transmission function executed by the image forming apparatus 100 according to the present embodiment will be described. Processing described below is realized by, for example, the CPU 102 of the image forming apparatus 100 reading a program for realizing each software module stored in the ROM 104 or the HDD 105 into the RAM 103 and executing it. Processing of this flowchart is started by the screen control unit 206 detecting that the user instructed calling of the image transmission function on a menu screen (not shown) displayed on the operation unit 107. Note that description of processing similar to the flowchart of FIG. 4 will be omitted. That is, step S701 to step S712 are similar to the processing of step S401 to step S412, and thus description thereof will be omitted.

In step S713, the alert notification unit 205 confirms whether or not the registration date and time of the alert notification destination is further in the past than a certain threshold. In other words, here, it is determined whether or not the alert notification destination is one registered within a predetermined period from the current time. For example, in a case where the threshold of the registration date and time is set to the past one day, it is confirmed whether or not the registration date and time is one day or more before the current date and time. In a case where the registration date and time is further in the past than the certain threshold, the process proceeds to step S710, and in a case where the registration date and time is not further in the past than the certain threshold, the process proceeds to step S711. That is, in the present embodiment, even if the alert notification destination and the transmission destination of the confidential document are the same, if the alert notification destination was registered within the past one day, alert notification is performed without deleting the alert notification destination.

As described above, the information processing apparatus according to the present embodiment notifies the pre-registered notification destination of the warning in a case where the pre-registered notification destination and the transmission destination of image data match and it is within a predetermined period after the pre-registered notification destination was registered. Accordingly, operation confirmation of the alert notification destination setting by the administrator himself/herself becomes possible.

### <Modifications>

Various modifications of the above embodiment of the present disclosure are possible. In the first to third embodiments described above, at the time of confidential document transmission which is a confidential information leakage operation, control for restricting alert notification to an email address in a case where the email address of the alert notification destination and the email address which is the transmission destination of the document match has been described. Meanwhile, a confidentiality level according to importance of information may be set for confidential information. In this way, in a case where a confidentiality level is set for each piece of confidential information, whether or not to perform alert notification may be switched according to the confidentiality level. This modification can be implemented in combination with each of the first to third embodiments described above.

As the confidential information, for example, information in a case where a character string such as “company secret” or “confidential” is included, and information including a character string or an image indicating an important theme or organizational information in an organization even in a case where such a character string is not included are also included. In a case where a confidentiality level is set in such a case, for example, in a case where a character string such as “company secret” or “confidential” is included, the confidentiality level may be set higher compared to other confidential information.

In a case where a confidentiality level is set for each piece of confidential information, when confidential information for which a high confidentiality level is set is transmitted, the alert notification unit 205 may perform control so as not to perform alert notification to a notification destination in a case where the transmission destination of image data and the notification destination of an alert match. On the other hand, at other confidentiality levels, control may be switched so as to perform alert notification to the notification destination even in a case where it matches the notification destination of the alert. Note that these controls are an example, and it is desirable to switch control according to specifications or an environment of an apparatus; for example, control opposite to the above-described control may be performed.

Also, in the first to third embodiments described above, control for transmitting data read by a scanner to a transmission destination regardless of alert notification has been described. However, the present disclosure is not intended to be limited to such control; for example, an inquiry may be made as to whether or not to permit transmission of data in alert notification, and transmission may be performed in a case where it is permitted (for example, in a case where a predetermined confirmation operation is performed). Alternatively, if the confidentiality level is equal to or higher than a predetermined level, the transmission itself may be canceled.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068351, filed Apr. 17, 2025 which is hereby incorporated by reference herein in its entirety.

What is claimed is:

1. An information processing apparatus comprising:
one or more memory devices that store a set of instructions; and
one or more processors that execute the set of instructions to:
acquire image data read from an original by a reading unit;
inspect whether or not predetermined information is included in the image data; and
according to an inspection result that the predetermined information is included in the image data, in a case where a pre-registered notification destination to which a warning is to be notified and a transmission destination of the image data are different, notify the pre-registered notification destination of a warning indicating that the image data including the predetermined information is to be transmitted.

2. The information processing apparatus according to claim 1, wherein the one or more processors execute instructions in the one or more memory devices to:
in a case where the pre-registered notification destination and the transmission destination of the image data match, not notify the warning indicating that the image data including the predetermined information is to be transmitted.

3. The information processing apparatus according to claim 2, wherein the one or more processors execute instructions in the one or more memory devices to:
in a case where the pre-registered notification destination and the transmission destination of the image data match, notify a notification destination different from the pre-registered notification destination of the warning indicating that the image data including the predetermined information is to be transmitted.

4. The information processing apparatus according to claim 1, wherein the one or more processors execute instructions in the one or more memory devices to:
in a case where the pre-registered notification destination and the transmission destination of the image data match and it is within a predetermined period after the pre-registered notification destination was registered, notify the pre-registered notification destination of the warning indicating that the image data including the predetermined information is to be transmitted.

5. The information processing apparatus according to claim 1, further comprising:
a storage unit that stores a table that defines a type for which a warning is to be given and a notification destination to notify of a corresponding warning for a respective type in association with each other,
wherein the type for which the warning is to be given includes a first type for warning that the image data including the predetermined information is to be transmitted,
and another type, and
the one or more processors execute instructions in the one or more memory devices to: in a case where the pre-registered notification destination associated with the first type and the transmission destination of the image data match, notify a warning to a notification destination defined in association with the other type.

6. The information processing apparatus according to claim 5, wherein
the other type includes at least one of a warning regarding a remaining amount of a consumable, a warning regarding a malfunction of the information processing apparatus,
and a warning regarding a license.

7. The information processing apparatus according to claim 1, wherein
the predetermined information is confidential information for which external transmission is restricted.

8. The information processing apparatus according to claim 7, wherein
confidentiality levels are respectively set for the confidential information, and the one or more processors execute instructions in the one or more memory devices to:
in a case where the pre-registered notification destination and the transmission destination of the image data match, switch whether or not to notify the warning indicating that the image data including the predetermined information is to be transmitted according to a confidentiality level of the confidential information which is the predetermined information.

9. The information processing apparatus according to claim 1, further comprising:
the reading unit that reads an image from an original.

10. The information processing apparatus according to claim 1, wherein the one or more processors execute instructions in the one or more memory devices to:
acquire an image read from an original by the reading unit provided in an external apparatus.

11. The information processing apparatus according to claim 1, wherein the one or more processors execute instructions in the one or more memory devices to: transmit image data to the transmission destination.

12. A method for controlling an information processing apparatus comprising:
acquiring image data read from an original by a reading unit;
inspecting whether or not predetermined information is included in the image data;
warning by, according to an inspection result that the predetermined information is included in the image data, in a case where a pre-registered notification destination to which a warning is to be notified and a transmission destination of the image data are different, notifying the pre-registered notification destination of a warning indicating that the image data including the predetermined information is to be transmitted; and
transmitting the image data to the transmission destination.

13. A non-transitory computer-readable storage medium storing a computer program for causing a computer to execute each step in a method for controlling an information processing apparatus, the method for controlling comprising: acquiring image data read from an original by a reading unit;
inspecting whether or not predetermined information is included in the image data;
according to an inspection result that the predetermined information is included in the image data, in a case where a pre-registered notification destination to which a warning is to be notified and a transmission destination of the image data are different,
notifying the pre-registered notification destination of a warning indicating that the image data including the predetermined information is to be transmitted; and
transmitting the image data to the transmission destination.
